(19) United States
(12) Patent Application Publication
(10) Pub. No.: US 2006/0150221 A1
(43) Pub. Date: Jul. 6, 2006

(54) Wireless output system for audio/video equipment

(75) Inventor: Raymond Chan, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: IDT Sonicvision Limited, Hung hom (HK)

(21) Appl. No.: 11/029,337

(22) Filed: Jan. 6, 2005

(51) Int. Cl. H04N 7/18

(52) U.S. Cl. 725/81

(57) ABSTRACT

A wireless output system for AV (audio and/or video) equipment, comprises a base unit for use with the equipment and an output unit for use elsewhere, the two units being communicable with each other via a wireless link. The base unit transmits a wireless AV signal corresponding to an AV signal received from the equipment for reception by the output unit, receives a wireless control signal from the output unit, and transmits a wireless control signal based on the one received for reception by the equipment. The output unit receives the wireless AV signal from the base unit and reproduces sound/image based on the received signal, receives a wireless control signal from a remote controller for the equipment, and transmits a wireless control signal corresponding to the one received for reception by the base unit.

The present invention relates to a wireless output system for use with audio and/or video (AV) equipment, such as CD or TV/DVD players.

### BACKGROUND OF THE INVENTION

Remote output systems are generally known especially in the field of audio equipment, such as cordless speakers or headphones. In a typical arrangement, a base receives an audio signal from an audio source and then transmits the signal via infrared or radio frequency, for example, to one or more remote speakers for reproducing the sound, music or the like. These systems are invariably designed for non-interactive, listening purpose alone.

The present invention seeks to provide a new or improved wireless output system that interacts with the source for enhanced functionality.

### SUMMARY OF THE INVENTION

According to the invention, there is provided a wireless output system for use with audio and/or video equipment with an associated remote controller, which system comprises a base unit for use with the equipment and an output unit for use at a remote location, the two units being communicable with each other via a wireless link. The base unit comprises an input for connection to the equipment for receiving an audio and/or video signal therefrom, a first transmitter for transmitting a wireless audio and/or video signal corresponding to the audio and/or video signal received at the input, for reception by the output unit, a receiver for receiving a wireless control signal from the output unit, and a second transmitter for transmitting a wireless control signal based on the wireless control signal received by the receiver, for reception by the equipment. The output unit comprises a first receiver for receiving the wireless audio and/or video signal from the base unit, an output device for reproducing sound and/or image based on the wireless audio and/or video signal received by the first receiver, a second receiver for receiving a wireless control signal from the remote controller, and a transmitter for transmitting a wireless control signal corresponding to the wireless control signal received by the second receiver, for reception by the base unit.

Preferably, the wireless link for communication between the base unit and the output unit comprises a radio frequency link.

Preferably, the wireless link for communication between the base unit and the output unit comprises a digital radio frequency link.

Preferably, the wireless link for communication between the base unit and the output unit comprises a full duplex radio frequency link.

More preferably, the wireless link is based on a frequency substantially of 5.8 GHz.

In a preferred embodiment, the second receiver of the output unit comprises an infrared receiver for receiving an infrared control signal from the remote controller, and the second transmitter of the base unit comprises an infrared transmitter for transmitting substantially the same infrared control signal to the equipment.

More preferably, the second transmitter of the base unit comprises a plurality of infrared light emitting diodes arranged to cover substantially all angular directions.

In a preferred embodiment, the output unit includes a speaker and a volume control circuit associated with the speaker for operation to control the volume of the sound generated by the speaker based on the wireless audio signal received by the first receiver, according to the wireless control signal received by the second receiver.

More preferably, the wireless audio signal for the operation of the volume control circuit comprises volume up, volume down and mute signals.

More or further more preferably, the output unit includes a learning circuit associated with the second receiver for learning and later recognizing the wireless control signal for the operation of the volume control circuit, and a memory for saving data of the learnt wireless control signal.

It is preferred that the output device comprises a display screen with speaker for reproducing images and sound originated from the equipment.

It is further preferred that the audio signal from said equipment includes at least one of text data and image data, and the output unit is adapted to process and display said at least one of text data and image data on the display screen.

### BRIEF DESCRIPTION OF DRAWINGS

The invention will now be more particularly described, by way of example only, with reference to the accompanying drawings, in which:

FIG. 1 is a schematic circuit diagram of a first embodiment of a wireless output system in accordance with the invention, the system having a base unit and an output unit;

FIG. 2 is a front view of the base unit of FIG. 1;

FIG. 3 is a rear view of the base unit of FIG. 2;

FIG. 4 is a schematic functional block diagram of the base unit of FIG. 1;

FIG. 5 is a front view of the output unit of FIG. 1;

FIG. 6 is a top plan view of the output unit of FIG. 5;

FIG. 7 is a schematic functional block diagram of the output unit of FIG. 1;

FIG. 8 is a schematic operation flow diagram illustrating an IR control learn function of the output unit of FIG. 1;

FIG. 9 is a schematic operation flow diagram illustrating IR repeat and remote control functions of the output system of FIG. 1;

FIG. 10 is a schematic functional block diagram of a base unit of a second embodiment of a wireless output system in accordance with the invention; and

FIG. 11 is a schematic functional block diagram of an output unit of the second output system.

### DETAILED DESCRIPTION OF PREFERRED EMBODIMENTS

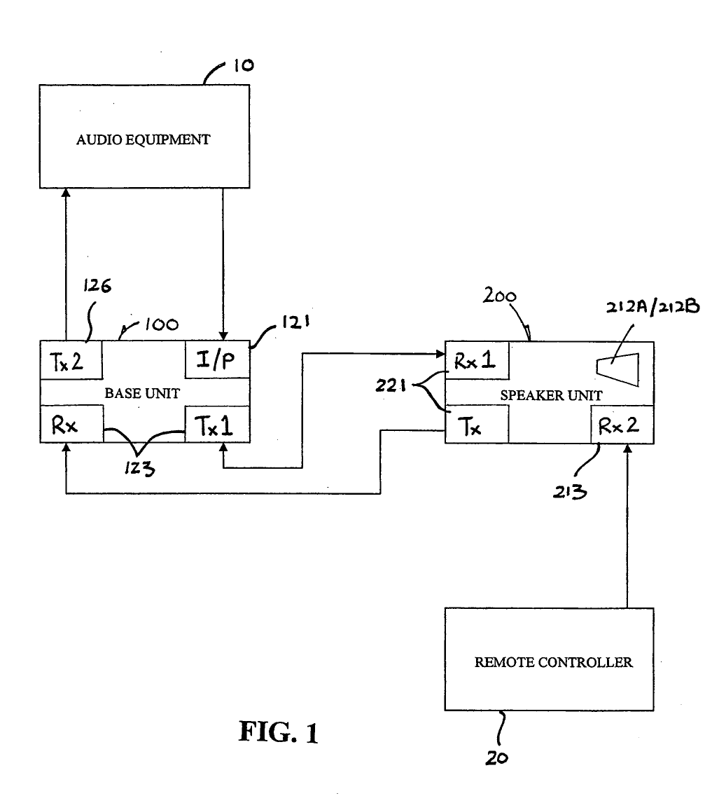

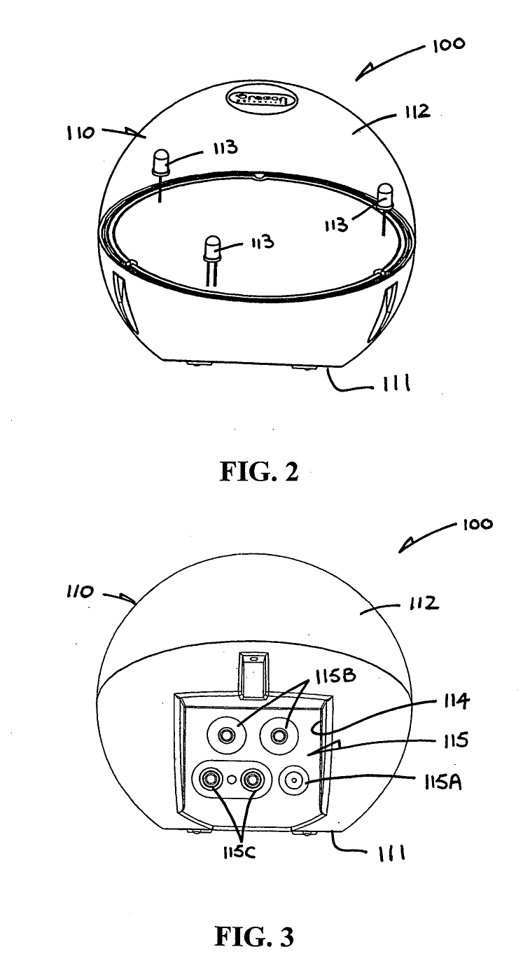

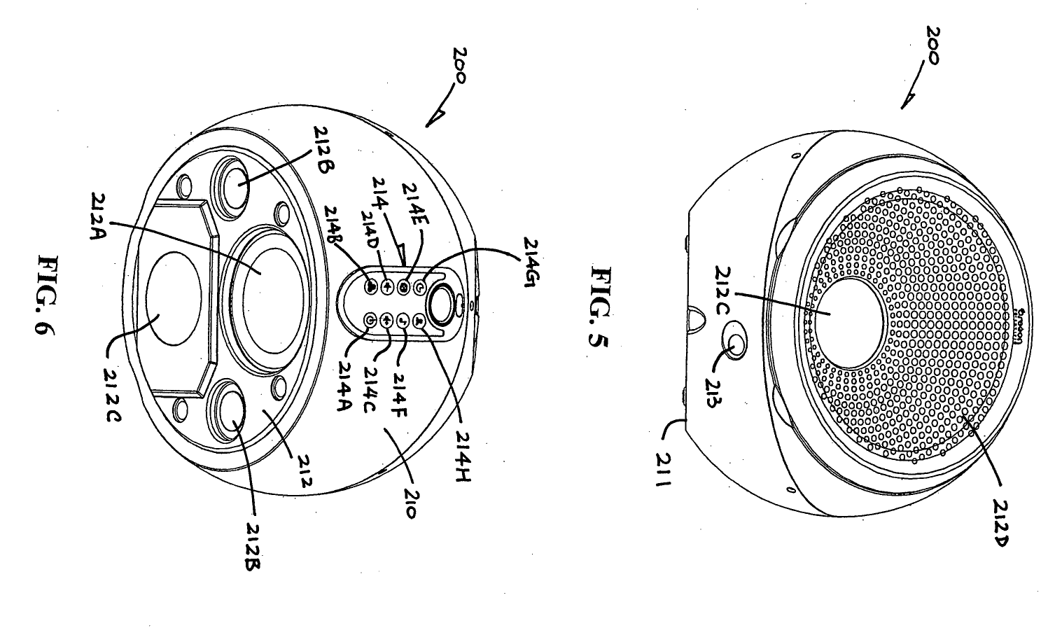

Referring initially to FIGS. 1 to 7 of the drawings, there is shown a first wireless output system embodying the invention, which is a wireless speaker system for use with audio equipment/source 10, such as a MP3 player, placed in the lounge for example and an IR (infrared) remote controller 20 associated with the equipment 10. The speaker system consists of a base unit 100 for use in front of and preferably adjacent the audio equipment 10 and a speaker unit 200 for use at a remote location such as in the master bedroom. The two units 100 and 200 are designed to co-operate and communicate with each other in a wireless manner, preferably via a wireless digital RF (radio frequency) link tuned at a frequency of 5.8 GHz

The base unit 100 has a generally spherical housing 110 that includes a flat bottom 111 for standing, a transparent or translucent top 112 and a rear recess 114. Three IR LEDs 113 are located symmetrically inside the housing 110 for emitting an IR control signal out through the top 112, 360° around the housing 110 i.e. all angular directions for full coverage. There are five sockets 115 located in the recess 114, namely a DC power jack 115A for AC/DC connection and two stereo jacks 115B and a pair of left/right line-in RCA sockets 115C for connection of up to three audio sources 10, such as TV, DVD, CD and/or MP3 equipment, to receive stereo audio signals therefrom. Internal DC battery power operation is possible.

Provided in the housing 110 is an electronic operating circuit 120 for the base unit 100, which incorporates an audio signal input circuit 121 connected to the input sockets 115B and 115C, an analogue-to-digital converter (ADC) 122 connected to the input circuit 121, and an RF transceiver (integrated circuit) 123 with antenna 124 connected to the ADC 122. The input circuit 121 processes the input audio signal, such as selecting amongst the audio sources i.e. channels, and the ADC 122 then converts the audio signal into digital format. The transmitter part of the transceiver 123 subsequently modulates (including compression), amplifies and transmits the digital signal as a wireless RF audio signal, which is equivalent or corresponds to the original input audio signal, for reception by the speaker unit 200.

The receiver part of the transceiver 123 serves to receive a wireless RF control signal from the speaker unit 200, which is equivalent to or represents an IR control signal given by the remote controller 20 for controlling the operation of the audio equipment 10, as hereinafter described.

The operating circuit 120 includes a main control unit (MCU) 125 that is connected to the input circuit 121 for controlling the same and also to the transceiver 123 for gathering and processing the aforesaid control signal therefrom and then feeding it to an IR transmitter 126 connected between the MCU 125 and the IR LEDs 113. The IR transmitter 126 serves to modulate, amplify and transmit the control signal as a wireless IR control signal for reception by the audio equipment 10.

The speaker unit 200 also has a generally spherical housing 210 that likewise includes a flat bottom 211 for standing but it is considerably larger than the base housing 110. On a slanting front 212 of this housing 210, there are mounted a subwoofer 212A centrally on the upper half, a pair of main speakers 212B on opposite left and right sides and a circular LCD display 212C right below the subwoofer 212A. A speaker grill 212D covers the housing front 212, while exposing the display 212C. The speaker unit 200 may also operate on AC/DC power, including a DC power jack at the back of its housing 210 for power connection.

The speaker unit 200 has an IR sensor 213 (the first one of a pair at the same location) right below the housing front 212 for receiving the aforesaid IR control signal from the remote controller 20. There is a keypad 214 atop the housing 210, which provides a power on/off key 214A, a channel selection key 214B, a pair of volume up (V+) and down (V−) keys 214C and 214D, a mute key 214E, an equalizer key 214F, a clock key 214G and a learn key 214H.

Provided in the speaker housing 210 is an electronic operating circuit 220 that incorporates, as connected in series, an RF transceiver (integrated circuit) 221 with antenna 222, a digital-to-analogue converter (DAC) 223 and an audio amplifier 224. The speaker transceiver 221 is tuned with the base transceiver 123 for its receiver part to receive the wireless digital RF audio signal transmitted by the base transceiver 123. The DAC 223 then restores the received audio signal into analogue format, and the audio amplifier 224 finally amplifies the analogue audio signal to drive the speakers 212A and 212B for sound generation.

The operating circuit 220 includes a main control unit (MCU) 225 that is connected to and controls the operation of the LCD display 212C, the transceiver 221 and the audio amplifier 224. The MCU 225 has built-in clock functions, or is otherwise connected to an external clock chip, for displaying time on the LCD display 212C with alarm and snooze (optional), etc., essentially in a conventional manner. Such clock functions are executed using the clock key 214G and the (volume) up and down keys 214C and 214D. Another built-in function of the MCU 225 is an audio equalizer (for bass and treble adjustment, etc.) that is activated using the equalizer key 214F.

The IR sensor 213 is connected to the MCU 225 for receiving and feeding the aforesaid IR control signal (originated from the remote controller 20) to the MCU 225, which in turn invokes the transceiver 221 to transmit the control signal as a wireless RF control signal for reception by the transceiver 123 of the base unit 100. In response, the base MCU 125 invokes the IR transmitter 126 and the IR LEDs 113 to reproduce and then transmit the IR control signal to the audio equipment 10 as if the reproduced or reconstructed IR control signal were directly issued by the remote controller 20. These components together perform a repeat function that repeats and passes on the IR control signal of the remote controller 20 via the wireless digital RF link from the speaker unit 200 to the base unit 100.

Certain system control signals are also transmitted via the wireless digital RF link from the speaker unit 200 to the base unit 100, such as an audio channel select signal issued by the speaker unit 200 using the channel selection key 214B for controlling the input circuit 121 of the base unit 100.

Most of the controls of the audio equipment 10, such as play/stop for a DVD or CD player or channel select for a TV set, can be passed on using the repeat function. The exceptions are volume control functions i.e. volume up (V+), volume down (V−) and mute, which can be implemented right at the speaker unit 200 given that the unit 200 is fundamentally an active speaker system. This would be necessary for those audio equipment 10 that usually do not have such functions built-in, such as DVD/CD players and pre-amplifiers. For performing the volume control functions, the speaker unit 200 must first learn to comprehend the relevant IR control signals of the remote controller 20, with the relevant learnt data being stored in a RAM memory 226 connected to the MCU 225.

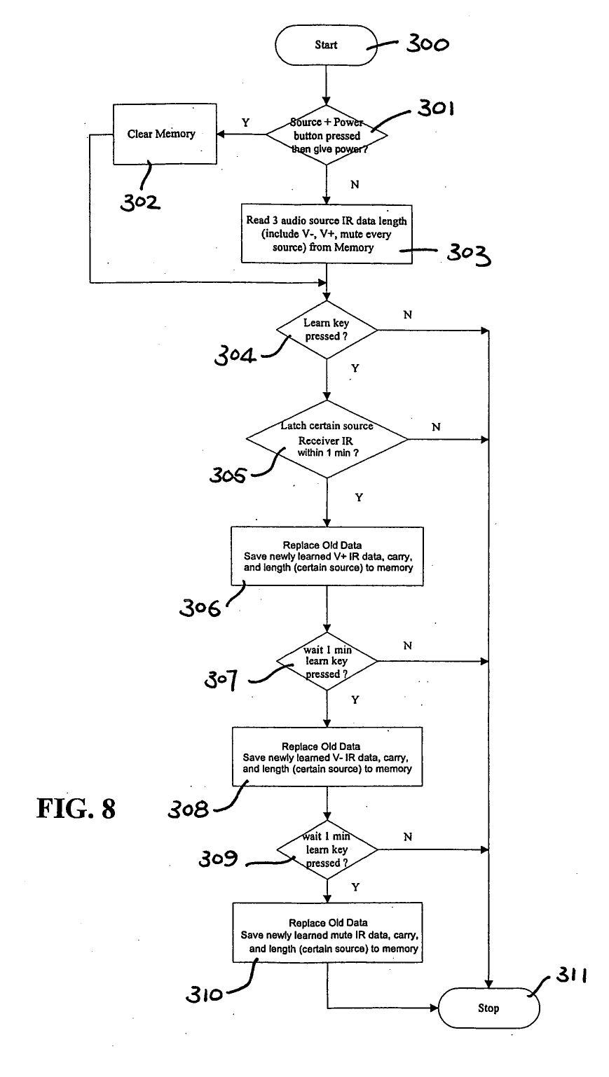

Learning by the speaker unit 200 of the IR remote volume control functions will now be described with reference to FIG. 8. To start (Box 300), a check is made to determine whether the power on/off button of the selected audio source 10 has been pressed i.e. turned on (Box 301). In the affirmative, the memory 226 is clear (Box 302), otherwise the IR data length (for V+, V− and mute functions) of each audio source 10 is read from the memory 226 (Box 303).

If the learn key 214H has been pressed (Box 304), learning mode is activated, otherwise the process comes to a stop (Box 311). In the learning mode, there is a first period of one minute for the second IR sensor 213 to receive an IR V+ signal from the relevant remote controller 20 (Box 305), which upon receipt will be saved in the memory 226 (Box 306), otherwise the process will terminate (Box 311). The saved data include carry frequency and data length. If the learning mode continues, the process will be repeated for an IR V− signal (Boxes 307 and 308) and subsequently for a mute IR signal (Boxes 309 and 310).

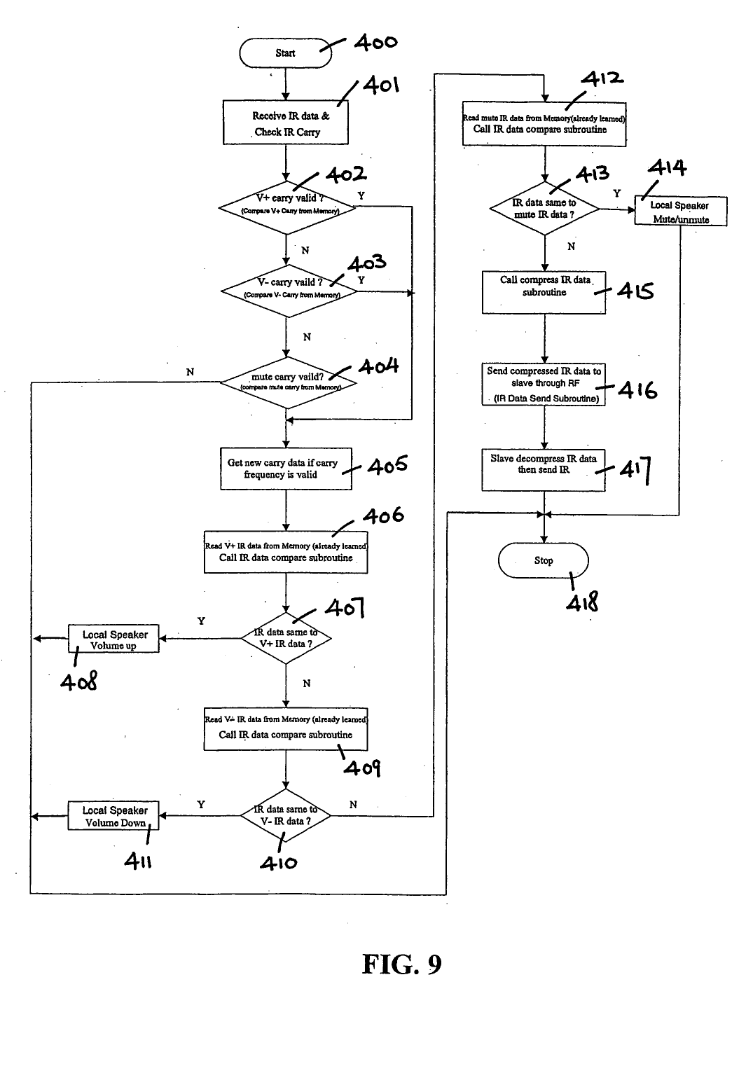

The normal operation of the speaker unit 200 performing its IR remote volume control and repeat functions in conjunction with the base unit 100 will now be described with reference to FIG. 9. To start (Box 400), a check is conducted as to whether an IR control signal is received (Box 401) from the remote controller 20 for the selected audio equipment 10. Upon receiving a V+ signal (Box 402) or a V− signal (Box 403) that is valid or recognized, the data carried therein is extracted (Box 405) and then compared with the V+ data (Box 406) or V− data (Box 409) previously learnt and saved in the memory 226. In the affirmative (Box 407/410), the volume of the speakers 212A and 212B will be turned up or down (Box 408/411) as appropriate, and the process will come to a stop (Box 418).

A similar process is carried out for a mute signal. Upon receiving a valid mute signal (Box 404), the data carried therein is compared with the saved mute data (Box 412). In the affirmative (Box 413), the speakers 212A and 212B are muted or unmated (Box 414) as appropriate, and the process will terminate (Box 418).

In the case that the IR control signal is neither a V+, a V− nor a mute signal, it will be compressed and converted, etc. (Box 415) and then transmitted as a RF control signal for reception by the base unit 100 (Box 416). The base unit 100 will subsequently decompress, transform and pass on the control signal as an IR control signal (Box 417) for reception by the audio equipment 10. The IR control signal is thus repeated and afterwards the process terminates (Box 418), with the speaker unit 200 awaiting another IR control signal from the remote controller 20.

In the case that the learning process for V+, V− and mute signals from the relevant remote controller 20 has not yet been carried out, these signals will simply be passed straight onto the audio source 10 whose speakers will then be adjusted in volume or muted/de-muted.

Broadly stated, the base and speaker units 100 and 200 are paired for communication with each other in either direction, or bi-directionally and more specifically in a full duplex manner, via radio frequency. That is to say, from the base unit 100 to the speaker unit 200 for transmitting audio signals to avoid speaker wiring, and in the opposite direction for transmitting remote control signals to the source audio equipment conveniently using the same radio frequency link, without consideration of line of sight, for example, as needed for infrared control.

The MP3 player 10 may have an output for MP3 tags stored inside the MP3 files, which are generally known as ID3 that includes songs' information e.g. names, lyrics and artists (text messages) and pictures (photographic images), etc. To make use of this information, the base unit 100 of the subject invention may include an extra input socket for connection to the ID3 output of the MP3 player 10 for extracting the ID3 data therefrom.

The ID3 data signal will be handled by the base unit 100 in generally the same manner as the input audio signal, that is to say, processed by the input circuit 121 and then compressed and transmitted by the transceiver 123 as a wireless RF data signal for reception by the speaker unit 200. Given that the ID3 data is already in digital form, involvement of the ADC 122 may not be necessary. At the speaker unit 200, the RF ID3 data signal will likewise be received by the transceiver 221 and then processed by the MCU 225 and finally shown on the display 212C. The MCU 225 should include a decoder program for decoding the ID3 data. The display of ID3 information is somewhat akin to displaying video images.

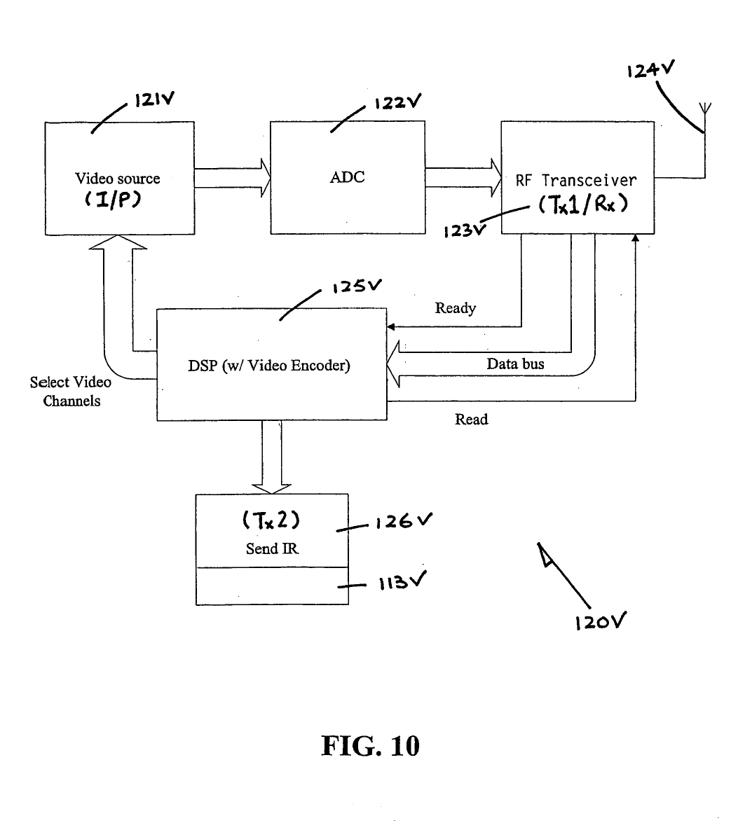

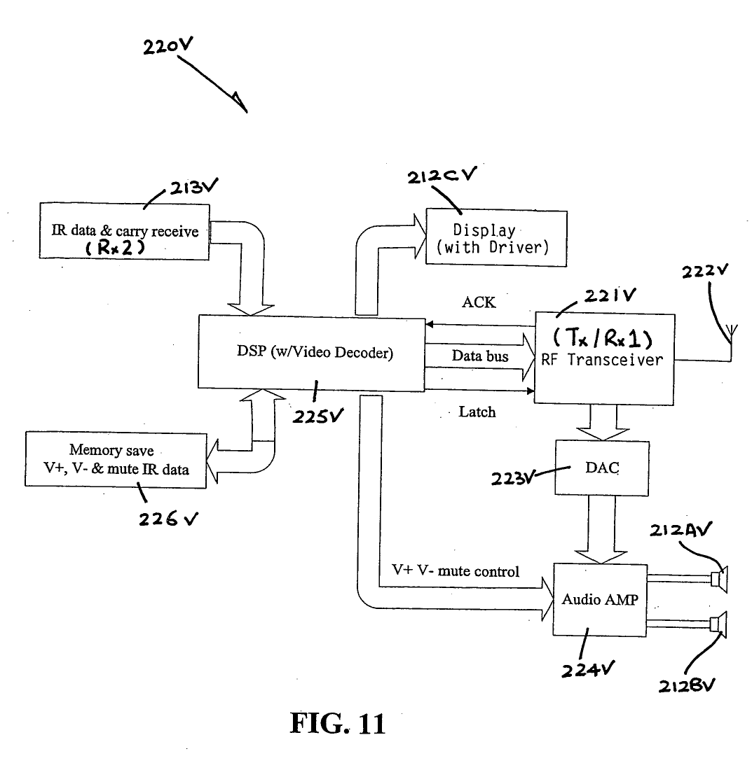

Reference is also made to FIGS. 10 and 11, which show a second wireless output system embodying the invention for use with an audio/video equipment, such as a TV or DVD player, placed in the lounge for example and an IR (infrared) remote controller for the equipment. The output system is formed by a base unit 100V and an output, video display unit 200V for reproducing images and sound originated from the video equipment. This output system is, in principle and operation, generally the same as the previous speaker system except that it now processes video (with audio) signals instead of only audio signals, with equivalent components designated by the same reference numerals suffixed by a letter “V”.

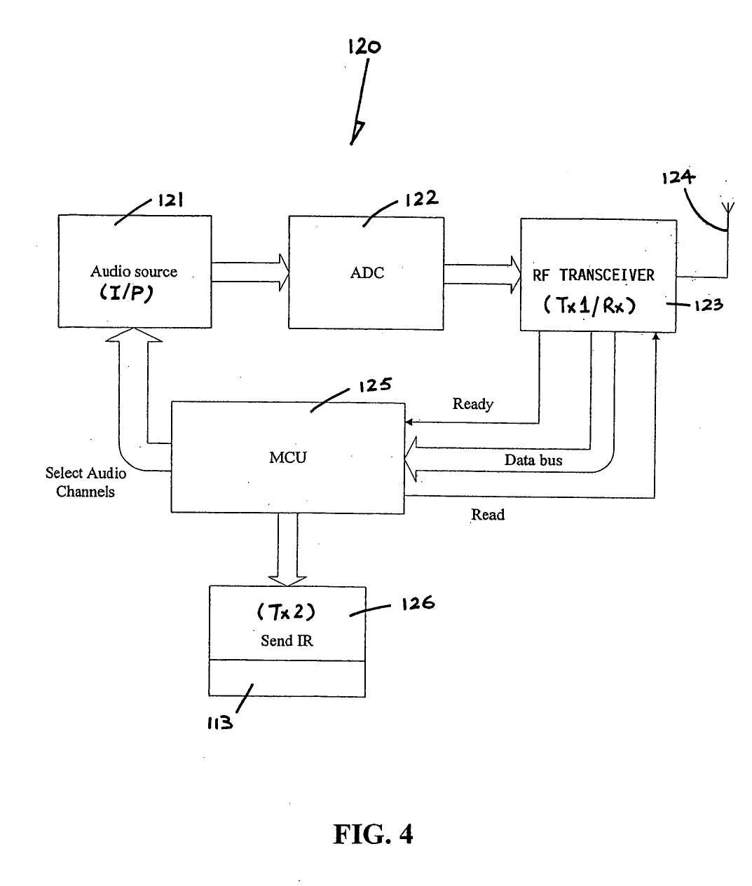

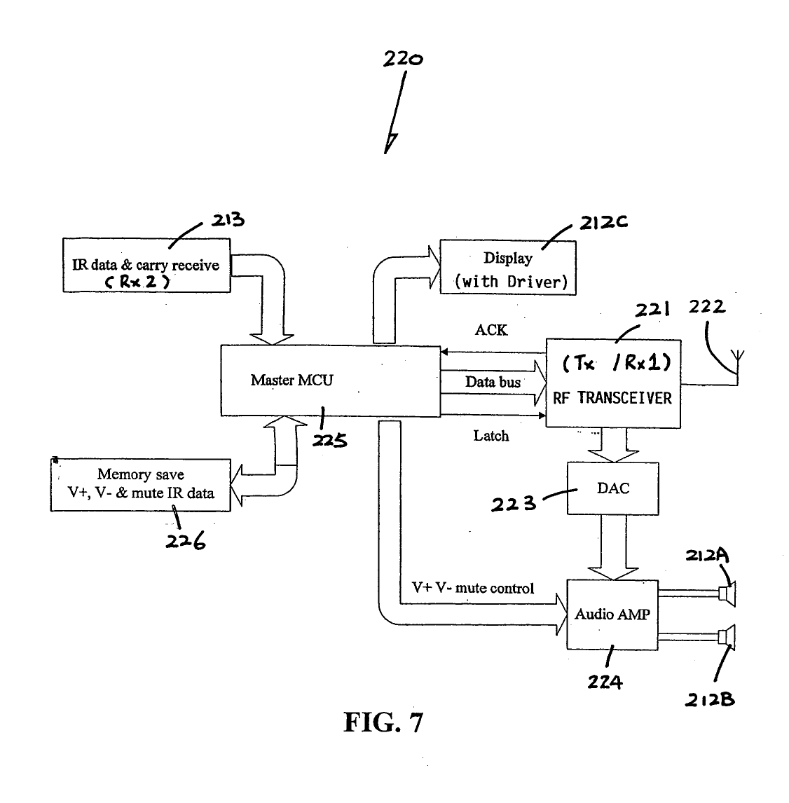

Most of the other figures, i.e. FIGS. 1 to 9 excluding FIGS. 4 and 7, as well as the relevant description on construction and operation are equally applicable to the second output system, with the word and features/content relating to “audio” being replaced by “video” whenever necessary or appropriate.

Both the base and the video display units 100V and 200V are used like their audio counterparts as previously described. Their basic constructions may also be the same as is apparent by comparing FIGS. 10 and 11 to earlier FIGS. 4 and 7, with the exception that their operating circuits 120V and 220V include respective DSP processors (digital signal processors) with video encoder/decoder 125V and 225V in place of the previous MCUs 125 and 225.

For displaying video, the display unit 200V may be made bigger to accommodate a larger LCD display 212CV that is equivalent to the earlier display 212C but upgraded to a suitably higher resolution. Alternatively, or as an addition, instead of having a built-in video display the display unit 200V may be designed for connection to an external video display screen or monitor, in which case the display unit 200V may keep the shape (spherical) or size as its audio counterpart.

The display unit 200V likewise includes the aforesaid leaning function so as to learn certain remote control functions that can be implemented locally and to effect the same in situ, i.e. volume adjustment and mute, as described in relation to the speaker unit 200. In the present case, ⁴there are more such local functions that can be handled by the display unit 200V, namely picture control functions i.e. brightness, contrast and colour, etc.

For use with a MP3 player, this output system may be made such that its base unit 100V can extract the ID3 data and its display unit 200V can display the same while outputting the songs.

It is envisaged that the remote volume control function performed at the output unit 200/220V may be relinquished and included in the general remote repeat function for simplicity in circuit design and operation.

The use of radio frequency for signal transmission and reception between the base and output units 100/100V and 200/200V is advantageous as this medium of transmission is non-directional, though it is not essential in the broadest sense as technologies advance, that is to say any other suitable types of wireless link may be employed instead.

The phrase “audio/video” used herein represents “audio and/or video” so that the phrase encompasses, inter alia, an audio element (feature or implication) with or without a video element.

The invention has been given by way of example only, and various other modifications of and/or alterations to the described embodiments may be made by persons skilled in the art without departing from the scope of the invention as specified in the appended claims.

1. A wireless output system for use with audio and/or video equipment with an associated remote controller, which system comprises:
a base unit for use with the equipment and an output unit for use at a remote location, the base and output units communicating with each other via a wireless link, wherein
the base unit comprises
an input for connection to the equipment for receiving an audio and/or video signal from the equipment;
a first transmitter for transmitting a wireless audio and/or video signal corresponding to the audio and/or video signal received at the input, for reception by the output unit;
a receiver for receiving a first wireless control signal from the output unit; and
a second transmitter for transmitting a second wireless control signal, based on the first wireless control signal received by the receiver, for reception by the equipment;
the output unit comprises
a first receiver for receiving the wireless audio and/or video signal from the base unit;
an output device for reproducing sound and/or an image based on the wireless audio and/or video signal received by the first receiver;
a second receiver for receiving a third wireless control signal from the remote controller; and
a transmitter for transmitting a fourth wireless control signal, corresponding to the third wireless control signal received by the second receiver, for reception by the base unit.

2. The wireless output system as claimed in claim 1, wherein the wireless link for communication between the base unit and the output unit comprises a radio frequency link.

3. The wireless output system as claimed in claim 1, wherein the wireless link for communication between the base unit and the output unit comprises a digital radio frequency link.

4. The wireless output system as claimed in claim 1, wherein the wireless link for communication between the base unit and the output unit comprises a full duplex radio frequency link.

5. The wireless output system as claimed in claim 2, wherein the wireless link is based on a frequency of substantially 5.8 GHz.

6. The wireless output system as claimed in claim 1, wherein the second receiver of the output unit comprises an infrared receiver for receiving an infrared control signal from the remote controller, and the second transmitter of the base unit comprises an infrared transmitter for transmitting substantially the infrared control signal to the equipment.

7. The wireless output system as claimed in claim 6, wherein the second transmitter of the base unit comprises a plurality of infrared light emitting diodes arranged to emit infrared light in substantially all angular directions.

8. The wireless output system as claimed in claim 1, wherein the output unit includes a speaker and a volume control circuit associated with the speaker to control volume of the sound produced by the speakers based on the wireless audio signal received by the first receiver, according to the third wireless control signal received by the second receiver.

9. The wireless output system as claimed in claim 8, wherein the wireless audio signal for the operation of the volume control circuit comprises volume up, volume down, and mute signals.

10. The wireless output system as claimed in claim 8, wherein the output unit includes a learning circuit associated with the second receiver for learning and recognizing the third wireless control signal for operation of the volume control circuit, and a memory for saving data of the third wireless control signal learned.

11. The wireless output system as claimed in claim 1, wherein the output device comprises a display screen with a speaker for reproducing images and sound originating from the equipment.

12. The wireless output system as claimed in claim 11, wherein the audio signal from the equipment includes at least one of text data and image data, and the output unit processes and displays the at least one of text data and image data on the display screen.
